(19) United States
(12) Patent Application Publication
(10) Pub. No.: US 2009/0127878 A1
(43) Pub. Date: May 21, 2009

(54) PNEUMATIC ANGULAR GRIPPER

(76) Inventors: Giuseppe MAFFEIS, Roncadelle (Brescia) (IT); Giuseppe Bellandi, Roncadelle (Brescia) (IT)

Correspondence Address: MCGLEW & TUTTLE, PC, P.O. BOX 9227, SCARBOROUGH STATION, SCARBOROUGH, NY, 10510-9227, US

(21) Appl. No.: 12/264,477

(22) Filed: Nov. 4, 2008

(30) Foreign Application Priority Data
Nov. 16, 2007 (IT) BS2007A000179

(51) Int. Cl. B66C 1/00

(52) U.S. Cl. 294/88

(57) ABSTRACT

This invention concerns a pneumatic angular gripper with gripper jaws (14), basically with an upside-down U shape, positioned astride the top of the gripper body and connected to respective fulcrums or oscillating arbours (13). The latter, turning and with self-supporting shape, are assembled in through cylindrical housings (18), parallel, provided transversely to the gripper body in an orthogonal plane to the stem of said control piston. The fulcrums or oscillating arbours are connected directly to the head connector (21) by means of sliding means (27, 33) and each to the respective gripper jaw (14) by anchoring means and rigid pulling spindles.

### FIELD OF THE INVENTION

This invention concerns in general the pneumatic gripper sector used for gripping items being machined and/or for automatic handling, and refers in particular to a pneumatic angular gripper, more especially the control means of the jaws in said type of gripper.

### STATE OF THE TECHNIQUE

Auto centring devices in the form of pneumatic grippers are already well-known and used in the field of machining and/or handling and/or automatic assembly of objects or items. Such grippers basically comprise a gripper body forming a chamber, a piston positioned and moving alternately in said chamber under the action of a fluid under pressure and a pair of gripper jaws pivoted to said body and movable in opposite directions on respective rotation axes. In the so-called angular grippers, the control piston is connected to the gripper jaws by a drawing means so that the linear movements of the piston correspond to the opening and closing angular movements of the jaws.

According to a known embodiment, in a pneumatic angular gripper the control piston has a stem that extends in a direction passing between the jaws, and each jaw oscillates on a supporting axis pin and is connected to the piston stem by a drawing means formed by a n articulation plate.

However, this realisation has some faults regarding the assembly and precision in controlling the rotation movements of the jaws when they move from the open to the closed position.

According to another embodiment, a drawing means is fixed axially to the control piston by a basically T shaped connecting means; each jaw has a guide slot at a distance from the respective rotation axis; and the connecting element holds on its opposite parts two rollers or pulling spindles that engage and slide in the slots of the jaws to provoke the angular movements of the latter in opposite directions in response to the linear movements of the piston.

In both cases, however the jaws are positioned inside the body of the gripper and each one is assembled on a fulcrum or oscillating arbour placed crossways in the body in an orthogonal plane to the stem of the control cylinder. This arrangement, however, means that in the body of the gripper both a housing for the jaws and the crossways housing for the pin or oscillating fulcrum of the joys must be provided, with the result that at least the execution and assembly of the gripper become laborious and costly to carry out.

### OBJECTS OF THE INVENTION

One object of the present invention is to provide a pneumatic angular gripper that avoids the drawbacks and disadvantages of the known technique, more simple and economic to manufacture and where the jaws are positioned and pulled externally on the two opposite sides of the body of the gripper and the fulcrums or oscillating arbours of said jaws are housed in the body and connected to the stem of the control piston in an innovative way.

Another object of the invention is to provide a pneumatic angular gripper with an optimum connecting system between the control piston and jaws such as to provoke a multiplication of the pulling force on the jaws when they near their closed position.

A further object of the invention is to provide a pneumatic angular gripper which can be fitted out in only one size, but with the possibility of increasing the gripping power as much as to double it without basically increasing its dimensions.

Said objects and others not mentioned are achieved, according to the invention, by a pneumatic angular gripper according to claim 1 and with the advantages that will be made manifest.

### BRIEF DESCRIPTION OF THE DRAWINGS

Further details of the invention will become evident in the continuation of the description carried out in reference to the enclosed indicative and not limitative drawings, in which:

FIG. 1 is an exploded view in perspective of the components of the pneumatic gripper proposed herein;

FIG. 2 is a view in perspective of the gripper when assembled and with the jaws in a closed position;

FIGS. 3, 4, 5 and 6 are, respectively, a front view, two lateral views from opposite sides, and a view from above of the gripper in FIG. 2; v

FIG. 7 is an enlarged cross section taken according to arrows A-A in FIG. 4 of the gripper with jaws in the closed position;

FIG. 8 is a similar section of the gripper but with the jaws in the open position; and

FIG. 9 is a view in perspective of a pneumatic angular gripper with an added module to increase the closing power; and

FIGS. 10 and 11 are two cross sections of the gripper in FIG. 9 with the jaws respectively in the closed and open position in the same way as the jaws in FIGS. 7 and 8.

### DETAILED DESCRIPTION OF THE INVENTION

In said drawings, the pneumatic angular gripper is designed globally by the number 10 and basically includes a prismatic gripper body 11, a pneumatic control piston 12, two fulcrums or oscillating arbours 13 and two gripper jaws 14.

The gripper body 11 can be a single piece made by sintering. Internally it forms a chamber 15 closed by a bottom plate 16 with the interposition of a seal 17 and has, at its top, two cylindrical transversal housings 18 which are in communication with said chamber by means of an intermediate bore 19. The two cylindrical housings 18 are parallel between them, in symmetrical positions compared to the intermediate bore 19 and lying in an orthogonal plane with regard to the axis of said bore. The top of the gripper body 11 has rounded opposite parts 11′ which centres of curvature are on the axis of said cylindrical housings.

The control piston 12 is housed in said chamber 15 and susceptible to alternating movements due to the action of a fluid under pressure, usually air, opportunely delivered in and discharged from said chamber 15. The piston 12 can be double or single-acting and in the later case it benefits in its movements by a return spring.

Anyway, the piston 12 is provided with a stem 20 extending in the intermediate bore 19 and has an end that protrudes between the transversal cylindrical housings 18 and to which is fixed a head connector 21.

The latter is basically at right angles to the stem 20 and has two arms 22 that extend from opposite parts of the stem itself towards said housings 18, each of which is provided with a transversal bore 23.

The fulcrums or oscillating arbours 13 are assembled in the two transversal cylindrical housings 18 of the gripper body 11, each supported in a self-supporting form and turning on its axis. The gripper jaws 14 have a basically upside down U conformation; they are placed astride the top of said body 11 and fixed to respective fulcrums of oscillating arbours by pulling means 24.

Each fulcrum or oscillating arbour 13 can be a single piece. Preferably however, and as shown in the drawings, it is made up of a couple of opposite cylindrical elements 25, each having longitudinal through bores 26 and a sliding slot 27, the latter in line with a front recess 28 and with a non radial orientation, but with a determined inclination compared with a radial plane. The two cylindrical elements 25 of each fulcrum or oscillating arbour 13 can be inserted in the respective cylindrical housing 18 from opposite sides of the gripper body 11 and matched face to face so that the relative through bores 26 and relative slots 27 coincide and their front recesses 28 together form a radial gap in which an arm 22 of the head connector 21 fixed to the stem 20 of the piston 12 finds its position. Each gripper jaw 14 can be formed from a single element, even if in the example shown in the drawings is made up of two lateral arms 29, which are positioned on the opposite sides of the gripper body on a level with a respective fulcrum or arbour 13 and which are fixed, by means of screws 30, to a cross piece 31 extending above the top of said gripper body. The cross piece of each jaw will also be provided with means to be able to fix a jaw, not shown, for gripping objects or items to be handled.

As regards to the whole described above and before assembling the gripper jaws 14, the fulcrums or arbours 13, that is the two cylindrical elements 25 that form each one, are housed in the seats 18 of the gripper body and fixed to the arms 22 of the head connector 21 of the stem 20 by means of a pulling pin 32 inserted in the bores 23 of said arms and in the slots 27 of said elements, with the possibility of each one to slide along the respective slot 27.

Then, the gripper jaws 14 are assembled, connecting the two arms 29 of each of them to the opposite ends of the respective fulcrum or oscillating arbour 13 by means of the pulling means 24. In the example illustrated, these pulling means are made up of conjunction spindles 33 inserted in the through bores 26 of each arm or oscillating fulcrum and engaging with their ends the locator bores 29′ provided in the internal face of the arbours of said jaws.

It should be noted that the constraint of the arms of each jaw 14 to the respective fulcrum or oscillating arbour 13 may also be anchored by means of a bolt 35 and that between each of said arms and relative fulcrum or oscillating arbour may also be provided with a seal 34 to close the housing 18 and to seal against dust or other substances.

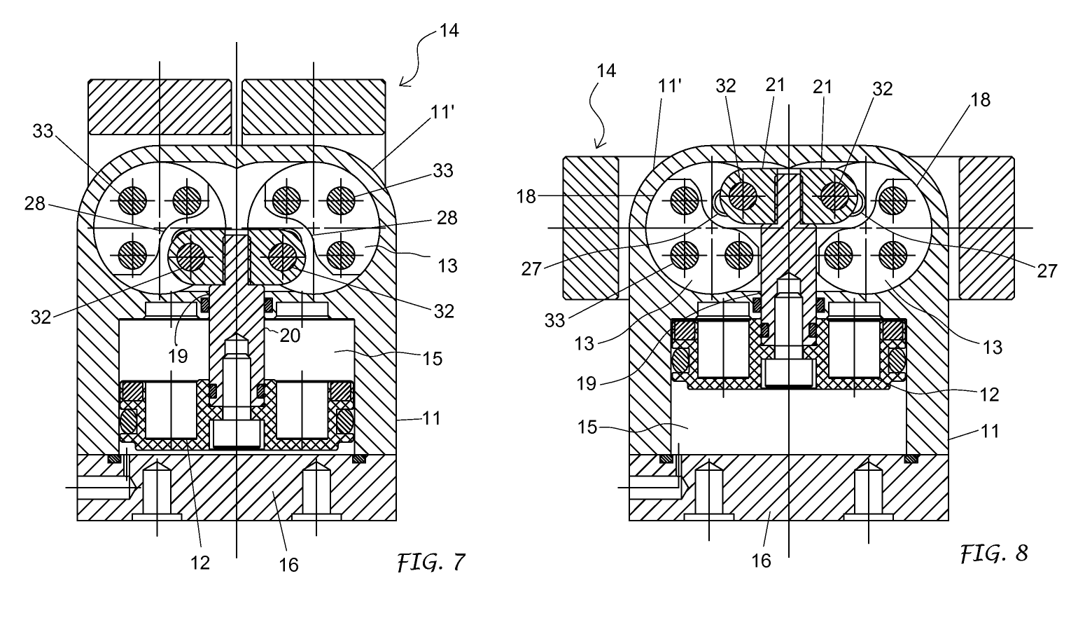

The functioning of the pneumatic gripper made in this way is evident. The alternative movements of the piston 12 in the chamber 15 of the gripper body cause, through the head connector 21 and thanks to the slots 27, the rotation in opposite directions of the fulcrums or oscillating arbours 13 and consequently of the jaws 14 for the closing and opening of the same—FIGS. 7 and 8. It should be noted that the mating between the head connector 21 and the fulcrums or oscillating arbours 13 and more in particular the pre-established slope of the slots 27 are such that the force applied on the jaws increases as the latter near their closing position creating an optimal grip on the part of the gripper.

The pneumatic angular gripper described above, besides being of simple and economic execution and able to increase the closing force of the jaws, it has at least the advantage of being able to be made using sintered components; to have the same capacity, to be extremely compact and of minimum dimensions compared with other known grippers; to have the advantage of a rolling friction between the pulling spindles 32 and the sliding slots 27 of the fulcrums or oscillating arbours (13; to have great usage flexibility to meet the numerous application requirements; to be able to be provided with a single size but having the possibility to easily increase the gripping capacity, and in which it is the arms of the gripper jaws that close the opposite ends of the cylindrical housings for the fulcrums or oscillating arbours for the axial restraining of the latter without the need to insert further elements.

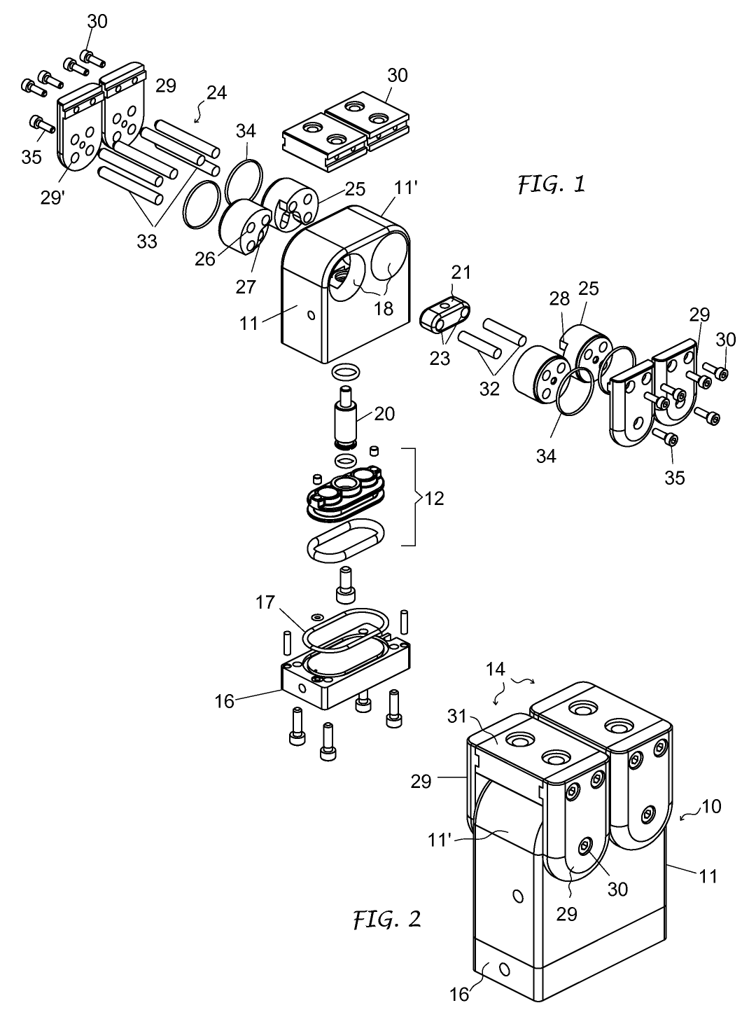

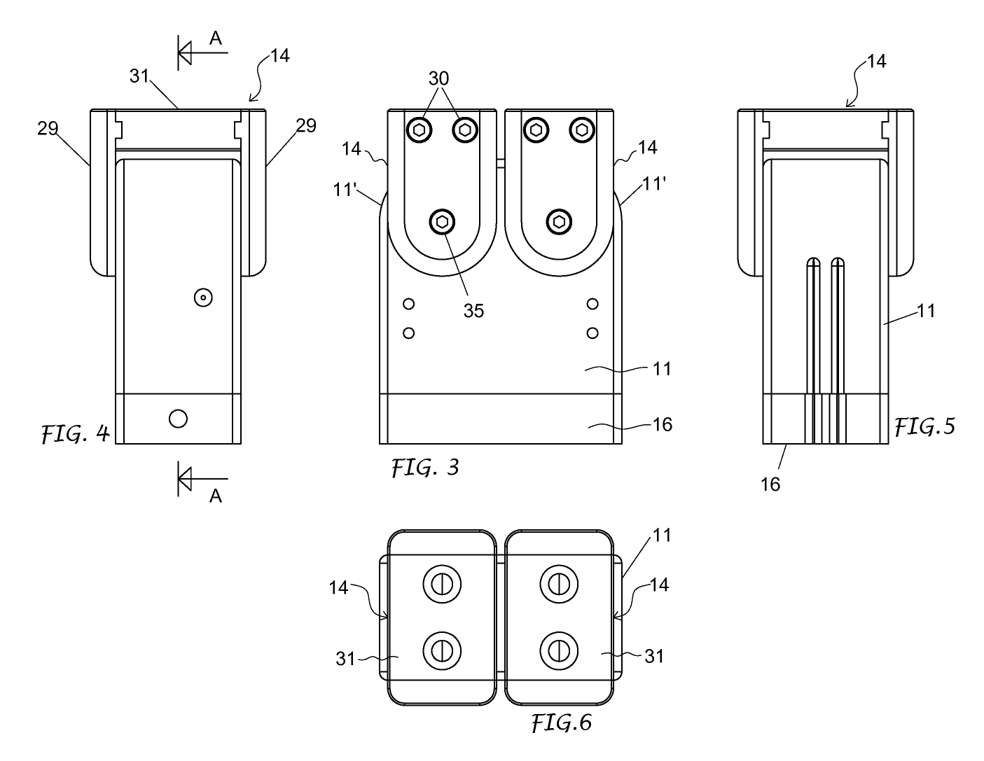

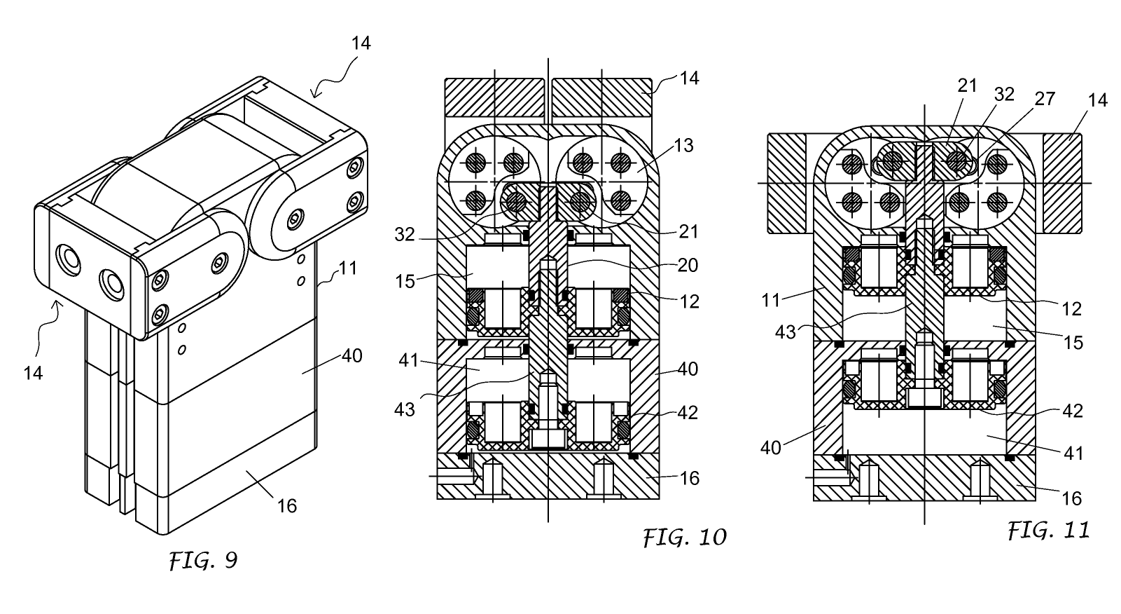

In fact, and as shown in FIGS. 9, 10 and 11, in which the same reference numbers are used to indicate the parts which are the same as those described in relation to the gripper shown in FIGS. 1-8, to the gripper body 11, between the latter and the base plate 16, an additional module 40 forming a chamber 41 for a second piston 42 with a relative stem 43 that connects in tandem with the stem 20 of the piston 12 present in the chamber of the gripper body 11, can be added.

The chambers with two pistons will be suitably fed with the fluid under pressure, being able in this way to double the closing power of the gripper with a minimum increase in its overall size, limited only to its height.

1. Pneumatic angular gripper, comprising a gripper body that forms a chamber (15) fed by a fluid under pressure, a control piston (12) housed and moving alternatively in said chamber under the action of the fluid under pressure, provided with a stem (20) with a head connector (21), two gripper jaws (14) associated with said body and susceptible to simultaneous rotations in opposite directions on respective fulcrums or oscillating arbours (13) between their open and closed positions, and means connecting said head connector (21) to said fulcrums or oscillating arbours (13) to cause the rotations of said jaws between said open and closed positions in response to the alternative movements of said piston, characterized in that said gripper jaws (14), shaped basically like an upside-down U, are positioned astride the top of the gripper body; the fulcrums or oscillating arbours (13) are assembled, turnable and self-supporting, in through, parallel, cylindrical housings (18) provided crossways to the gripper body in an orthogonal plane to the stem of said control piston; and the fulcrums or oscillating arbours are directly connected to said head connector (21) by means of sliding means (27,33) and each one to the respective gripper jaw (14) by rigid connecting and pulling means.

2. Pneumatic angular gripper according to claim 1, wherein each gripper jaw (14) has two lateral arms (29), positioned on opposite sides of the gripper body on a level with a respective fulcrum or oscillating arbour (13) and connected to a traverse (31) extending above the top of said gripper body (11), each jaw being made either of a single piece or of several components with the traverse provided with a means for fixing a gripper jaw.

3. Pneumatic angular gripper according to claim 2, wherein each fulcrum or oscillating arbour (13) has a radial recess, some longitudinal through bores (26) and a sliding slot (27), in which the head connector (21) of the stem of the control piston has two opposite arms facing towards and inserted in said radial recesses of the fulcrums or oscillating arbours, in which each arm of said head connector is connected to a respective fulcrum or oscillating arbour (13) by means of a pulling pin (32) and sliding in the slot (27) of said fulcrum or arbour, and in which each fulcrum or oscillating arbour (13) is connected to the lateral arms (29) of a respective jaw (14) by means of pulling spindles (33) that extend into the longitudinal bores (26) of said fulcrum or arbour.

4. Pneumatic angular gripper according to claim 3, wherein each fulcrum or oscillating arbour (13) is a single piece and its sliding slot (27) is sloped in a different plane from a radial plane of said fulcrum or arbour.

5. Pneumatic angular gripper according to claim 3, wherein each fulcrum or oscillating arbour (13) comprises a pair of opposite cylindrical elements (25), each one having longitudinal through bores (26) and a sliding slot (27), the latter in line with a front recess (28) in said element and with an inclined positioning with regard to a radial plane, and in which the two cylindrical elements (25) can be inserted in the respective cylindrical housing (18) from opposite sides of the gripper body (11) and placed face to face so that the relative longitudinal bores (26) and the relative slots (27) coincide and that said front recess (28) form together a radial cavity in which an arm (22) of the head connector finds its stability (22) fixed to the stem (20) of the piston (12).

6. Pneumatic angular gripper according to claim 3, wherein the lateral arms (29) of the jaws (14) have internal locator bores (29′) to receive the ends of the pulling spindles (33) passing through the respective fulcrum or oscillating arbour (13) and are fixed to said fulcrum or oscillating arbour by at least one anchoring bolt (35).

7. Pneumatic angular gripper according to claim 2, wherein the lateral arms (29) of the gripper jaws (14) close the opposite ends of the cylindrical housings (18) accommodating the opposite ends of the cylindrical housings with the interposition of seals (34) to prevent dust and other substances entering.

8. Pneumatic gripper according to claim 1, wherein the chamber (15) for the control piston (12) in the gripper body (11) is closed by an end plate (16) with the interposition of a seal, and in which between said gripper body and said end plate an additional module (40) can be provided forming a chamber (41) for a second piston (42) with a stem (43) which connects in tandem with the stem (20) of the piston (12) in the chamber of the gripper body (11) to increase the capacity of the gripper.
